(19) United States
(12) Patent Application Publication
(10) Pub. No.: US 2016/0194229 A1
(43) Pub. Date: Jul. 7, 2016

(54) POLY-MAGNETIC FILTER DEVICE FOR HOT WATER HEATERS AND GAS WATER HEATERS

(71) Applicant: HABIBI MEHDI, TEHRAN (IR)

(72) Inventor: HABIBI MEHDI, TEHRAN (IR)

(21) Appl. No.: 14/588,720

(22) Filed: Jan. 2, 2015

(51) Int. Cl. C02F 5/08; C02F 1/48

(52) U.S. Cl. CPC C02F 5/086; C02F 1/481; C02F 2201/48

(57) ABSTRACT

The various embodiments herein provide a poly-magnetic filter for enhancing the filtering effect on the sediment of limestone in the affected water. The filter doubles the effect of neutralizing the limestone sediment in the water molecules by simultaneously using a magnetic field and a plurality of polyphosphate crystal in a single filter. The filter is placed inside or outside a water-using domestic appliance or industrial appliance. The filter is installed at water inlet point of the appliance. The embodiments herein further provide a filtering method which primarily regulates the water molecules using the magnetic arc and further softens the water molecules using poly-phosphate crystals.

### TECHNICAL FIELD

The embodiments herein generally relates to water purification systems and methods. The embodiments herein particularly relates to a water filtration system hot water heaters and gas water heaters. The embodiments herein more particularly relates to polymagnetic filter devices for removing lime sedimentation in hot water heaters, gas water heaters and gas water heater packages.

### BACKGROUND

1. Description of the Related Art

Hard water has a high mineral content, usually consisting of mostly calcium and magnesium. In fact, the measure of water hardness is expressed in various units to express how much calcium carbonate is present in a given volume of water. The water hardness is expressed in units such as ppm (parts per million), gpg (grains per gallon), or mg/L (milligrams per liter). The hard water poses problems with the plumbing in homes. The hard water forms hard deposits of calcium Called scaling thereby affecting faucets, shower-heads, dishwashers, and heating elements of water heaters. The scaling reduces water flow, heating efficiency, and leave spots on the dishes.

A water filter system is used to remove the sedimentary limestone (calcium carbonate) that appears in hot water heaters, gas water heaters and gas water heater package. Normally, a magnetic arc or exclusive polyphosphate crystals are adopted to regulate the water molecules to remove the lime stuck to water molecules and the water molecules are lead towards polyphosphate crystal housing. As a result, the lime molecules were softened and water heater is not damaged. Currently available water filters have sole physical effect of magnetic arc or effect of the polyphosphate salt crystals on lime molecules. These two filters individually have various drawbacks such as lack of effect or coordination to protect the devices. For instance, the disadvantage of filters containing crystal has a limited effect of crystals due to irregularity of water molecules and the expiration of polyphosphate crystals that leads to failure in removing the lime. In this case, the user is aware of the filter failure only after the device is damaged and has to pay a lot to recompense the damage.

The problem of lime sedimentation in hot water heaters and gas water heaters is reduced utilizing positional effect of either magnet softener or using polyphosphate crystal softeners. With the sole physical effect of magnetic arc or the sole chemical effect of polyphosphate crystals, the present day water filters are not able to neutralize the water deposits. As a result, sediments are produced in hot water heaters and gas water heater that cause damage to heat exchanger and gas water heater package coil due to separate working of the two filters over time. Moreover, in case of the user's lack of attention in regard with crystals' expiration, the filter with the magnetic arc has a relative functionality on lime molecules.

In the view of aforementioned drawbacks, there is a need for a water filter uses the magnetic effect and chemical effect to remove a large amount of lime sedimentation in water heaters.

The above mentioned shortcomings, disadvantages and problems are addressed herein and which will be understood by reading and studying the following specification.

### OBJECTIVES OF THE EMBODIMENTS HEREIN

The primary object of the embodiments herein is to provide a poly-magnetic filter to utilize both the physical effects and chemical effects by deploying both a magnetic arc and polyphosphate crystals for enhancing a filtering effect on the sediment of limestone in the water.

Another object of the embodiments herein is to provide a water Filter which doubles the effect of neutralizing the limestone simultaneously by using magnetic arc and polyphosphate crystal in a single filter.

Yet another object of the embodiments herein is to provide a method for providing a doubling filtering impact on regularized water molecules by means of magnetic arc that go through the crystal housing and strengthen the crystals' functionality.

Yet another object of the embodiments herein is to provide a water filter which works on a sole function of magnetic arc for removing the sediment from water, when the polyphosphate crystals in filter are expired.

Yet another object of the embodiments herein is to provide a poly-magnetic filter provided with two output ports for easier installation and for preventing unnecessary costs.

These and other objects and advantages of the present invention will become readily apparent from the following detailed description taken in conjunction with the accompanying drawings.

### SUMMARY

The various embodiments herein provide a poly-magnetic filter for enhancing a filtering effect on the sediment of limestone in the affected water. The filter doubles the effect of neutralizing the limestone sediment in the water molecules by simultaneously using a magnetic field and a plurality of polyphosphate crystals in a single filter. The filter is placed inside or outside a particular water-using domestic appliance or industrial appliance, wherein, the filter is installed at a water inlet point of the appliance.

The poly-magnetic filter for separating a plurality of limestone molecules in untreated water comprises: a filter body, a transparent housing, a plastic flange, an water inlet port, at least two outlet ports, a magnetic power unit, and a polyphosphate cartridge. The transparent housing is configured for storing untreated water and a cartridge comprising polyphosphate crystals. The filter body comprises a rim around a top opening. The transparent housing is connected to the top opening of the filter body. The plastic flange is in form of a ring and comprises a rim used for fastening the transparent housing to the filter body. The water inlet port is configured for providing an entry to untreated water into the filter body for treatment. The two outlet ports are configured for providing an exit to a filtered water. A user chooses any one of the two outlet ports depending on convenience. The magnetic power unit configured for breaking down the limestone molecules in water using a magnetic field effect. The polyphosphate cartridge mounted in a removable manner on the transparent housing. The polyphosphate cartridge is configured to soften the water treated by the magnetic power unit.

According to an embodiment herein, the magnetic power unit is positioned prior to the polyphosphate cartridge but after the water inlet port. The magnetic power unit softens the untreated water. The polyphosphate cartridge filters the softened water obtained from the magnetic power unit.

According to an embodiment herein, the water inlet port is arranged at an end of the filter body. The inlet port is connected to an output pipe of a water supply source.

According to an embodiment herein, the two outlet ports are arranged on the filter body. A first outlet port is placed opposite to the inlet port and is perpendicular to a second outlet port. The outlet port is selected depending on the position of a pipe system of the appliance.

According to an embodiment herein, the first outlet port is connected to an input valve of the appliance and the second outlet port is closed with a covering cap or vice versa.

According to an embodiment herein, the magnetic power unit comprises at least two magnetic blocks. The magnetic blocks are in a form of bar magnets. Each magnetic block of the magnetic power unit is permanent magnet of rare-earth material. The magnetic block is preferably a Neodymium magnet.

According to an embodiment herein, the magnetic power unit comprises a cap for covering the top opening of the magnetic power unit. The cap is provided to enclose the magnet blocks.

According to an embodiment herein, the transparent housing is configured to store the treated water coming from the magnetic power unit. The transparent housing is made up of Styrene-acrylonitrile resin material or polycarbonate material.

According to an embodiment herein, the polyphosphate cartridge comprises an opening at a lower part through which the treated water from the magnetic power unit enters into the polyphosphate cartridge.

According to an embodiment herein, the polyphosphate cartridge comprises a plurality of polyphosphate beads formation unit for removing the limestone molecules from the untreated water.

According to an embodiment herein, the polyphosphate cartridge comprises a cover having an opening for passing the filtered liquid from the upper portion of the polyphosphate cartridge.

The various embodiments herein provide a method for removing a plurality of limestone molecules from an untreated water using a poly-magnetic filter. The method comprises the following steps. The poly-magnetic filter is installed between a water supply source and a particular appliance. The untreated water containing sediments is passed to a filter through a water inlet port of the filter. The untreated water is passed through a magnetic power unit of the filter. The plurality of limestone molecules is broken down due to a magnetic effect of the magnet blocks in the magnetic power unit of the filter. The softened water from the magnetic power unit is passed into a transparent housing of the filter. The lime molecules are dissociated from the water molecules, as the treated water passes through a polyphosphate cartridge present in the transparent housing of the filter. The sediment-free, filtered water is output nom a water outlet port of the filter.

According to an embodiment herein, the filter body is installed between an output pipe of the water supply source and an input valve of the appliance. The polyphosphate cartridge along with the transparent housing is fixed to the filter body after the installation, using a plastic flange.

According to an embodiment herein, the magnetic field created in the magnetic power unit, breaks down the plurality of limestone molecules in the untreated water. The magnetic field breaks down the limestone molecules into soft powdery precipitate tape type talc which remains in form of suspension.

According to an embodiment herein, the untreated water is filtered twice by passing the treated water from the magnet power unit to the polyphosphate cartridge. The remaining limestone molecules react with sodium hexamethazone in the polyphosphate cartridge, to cause a total removal of the limestone molecules in filtered water.

According to an embodiment herein, the filtered water is removed through one of the two water outlet ports of the filter. The outlet port is selected depending on a pipe system of the appliance. A first water outlet port is selected when the pipe system is arranged in parallel to a plane of the filter. A second outlet port is selected when the pipe system is perpendicular to the plane of the filter.

These and other aspects of the embodiments herein will be better appreciated and understood when considered in conjunction with the following description and the accompanying drawings. It should be understood, however, that the following descriptions, while indicating preferred embodiments and numerous specific details thereof are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a perspective view of a poly-magnetic filter, according to an embodiment herein.

FIG. 2 illustrates a perspective view of the poly-magnetic filter, exposing the magnetic blocks in the magnetic power unit, according to an embodiment herein.

FIG. 3A, 3B and 3C illustrate a side view of the poly-magnetic filter indicating a plurality of configurations for connecting a piping system of an appliance to output ports of the poly-magnetic filter, according to an embodiment herein.

FIG. 4 illustrates a flowchart explaining the process steps involved in a method for removing a plurality of limestone molecules from untreated water using a poly-magnetic filter, according to embodiment herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a poly-magnetic filter for enhancing a filtering effect on the sediment of limestone in the affected water. The filter doubles the effect of neutralizing the limestone sediment in the water molecules by simultaneously using a magnetic field and a plurality of polyphosphate crystals in a single filter. The filter is placed inside or outside a particular water-using domestic appliance or industrial appliance, wherein the filter is installed at a water inlet point of the appliance.

The poly-magnetic filter for separating a plurality of limestone molecules in untreated water comprises: a filter body, a transparent housing, a plastic flange, an water inlet port, at least two outlet ports, a magnetic power unit, and a polyphosphate cartridge. The transparent housing is configured for storing untreated water and a cartridge comprising polyphosphate crystals. The filter body comprises a rim around a top opening. The transparent housing is connected to the top opening of the filter body. The plastic flange is in form of a ring and comprises a rim used for fastening the transparent housing to the filter body. The water inlet port is configured for providing an entry to untreated water into the filter both for treatment. The two outlet ports are configured for providing an exit to a filtered water. A user chooses any one of the two outlet ports depending on convenience. The magnetic power unit configured for breaking down the limestone molecules in water using a magnetic field effect. The polyphosphate cartridge mounted in a removable manner on the transparent housing. The polyphosphate cartridge configured to soften the water treated by the magnetic power unit.

According to an embodiment herein, the magnetic power unit is positioned prior to the polyphosphate cartridge but after the water inlet port. The magnetic power unit softens the untreated water. The polyphosphate cartridge filters the softened water obtained from the magnetic power unit.

According to an embodiment herein, the water inlet port is arranged at an end of the filter body. The inlet port is connected to an output pipe of a water supply source.

According to an embodiment herein, the two outlet ports are arranged on the filter body. A first outlet port is placed opposite to the inlet port and is perpendicular to a second outlet port. The outlet port is selected depending on the position of a pipe system of the appliance.

According to an embodiment herein, the first outlet port is connected to an input valve of the appliance and the second outlet port is closed with a covering cap or vice versa.

According to an embodiment herein, the magnetic power unit comprises at least two magnetic blocks. The magnetic blocks are in a form of bar magnets. Each magnetic block of the magnetic power unit is permanent magnet of rare-earth material. The magnetic block is preferably a Neodymium magnet.

According to an embodiment herein, the magnetic power unit comprises a cap for covering the top opening of the magnetic power unit. The cap is provided to enclose the magnet blocks.

According to an embodiment herein, the transparent housing is configured to store the treated water coming from the magnetic power unit. The transparent housing is made up of Styrene-acrylonitrile resin material or polycarbonate material.

According to an embodiment herein, the polyphosphate cartridge comprises an opening at a lower part through which the treated water from the magnetic power unit enters into the polyphosphate cartridge.

According to an embodiment herein, the polyphosphate cartridge comprises a plurality of polyphosphate beads formation unit for removing the limestone molecules from untreated water.

According to an embodiment herein the polyphosphate cartridge comprises a cover having an opening for passing the filtered liquid from the upper portion of the polyphosphate cartridge.

The various embodiments herein provide a method for removing plurality of limestone molecules from an untreated water using a poly-magnetic filter. The method comprises the following steps. The poly-magnetic filter is installed between a water supply source and a particular appliance. The untreated water containing sediments is passed to a filter through a water inlet port of the filter. The untreated water is passed through a magnetic power unit of the filter. The plurality of limestone molecules is broken down due to a magnetic effect of the magnet blocks in the magnetic power unit of the filter. The softened water from the magnetic power unit is passed into a transparent housing of the filter. The lime molecules are dissociated from the water molecules, as the treated water passes through a polyphosphate cartridge present in the transparent housing of the filter. The sediment-free, filtered water is output from a water outlet port of the filter.

According to an embodiment herein, the filter body is installed between an output pipe of the water supply source and an input valve of the appliance. The polyphosphate cartridge along with the transparent housing is fixed to the filter body after the installation, using a plastic flange.

According to an embodiment herein, the magnetic field created in the magnetic power unit, breaks down the plurality of limestone molecules in the untreated water. The magnetic field breaks down the limestone molecules into soft powdery precipitate tape type talc which remains in form of suspension.

According to an embodiment herein, the untreated water is filtered twice by passing the treated water from the magnet power unit to the polyphosphate cartridge. The remaining limestone molecules react with sodium hexamethazone in the polyphosphate cartridge, to cause a total removal of the limestone molecules in filtered water.

According, to an embodiment herein, the filtered water is removed through one of the two water outlet ports of the filter. The outlet port is selected depending on a pipe system of the appliance. A first water outlet port is selected when the pipe system is arranged in parallel to a plane of the filter. A second outlet port is selected when the pipe system is perpendicular to the plane of the filter.

The various embodiments herein provide a poly-magnetic filter for removing the limestone sediments in untreated water received from a water supply source. On contrary to exclusive magnet filter and exclusive polyphosphate filter, the poly-magnetic filter has a double impact on the untreated, thus neutralizing water deposits in the various appliances. The magnetic filter further facilitates or enhances a longevity of the appliances by preventing sedimentation of limestone. The poly-magnetic filter simultaneously makes use of the process of chemical effect and physical effect as the filter utilizes both the magnetic water treatment and polyphosphate water softening methods. By means of double effect, the limestone molecules struck with the water molecules are broken down and filtered. Another advantage with the poly-magnetic filter is that the filter survives with using, the magnetic effect to lessen the damage to the required appliance even when the polyphosphate crystals in the filter are exhausted. In case of a user's lack of attention in regard with crystals' expiration, the filter with its magnetic effect has a relative functionality on the limestone molecules.

The poly-magnetic filter is configured for separating limestone molecules from water molecules and purifying the untreated water impending from the water supply source. The filtered water is provided to plumbing system and water-using appliances like washing machines, thereby eliminating the clogging in plumbing system and preventing scales in the appliances. The filter is placed inside or outside of a particular water-using appliance. The filter is installed between an output valve of the water supply source and a water input valve of the appliance.

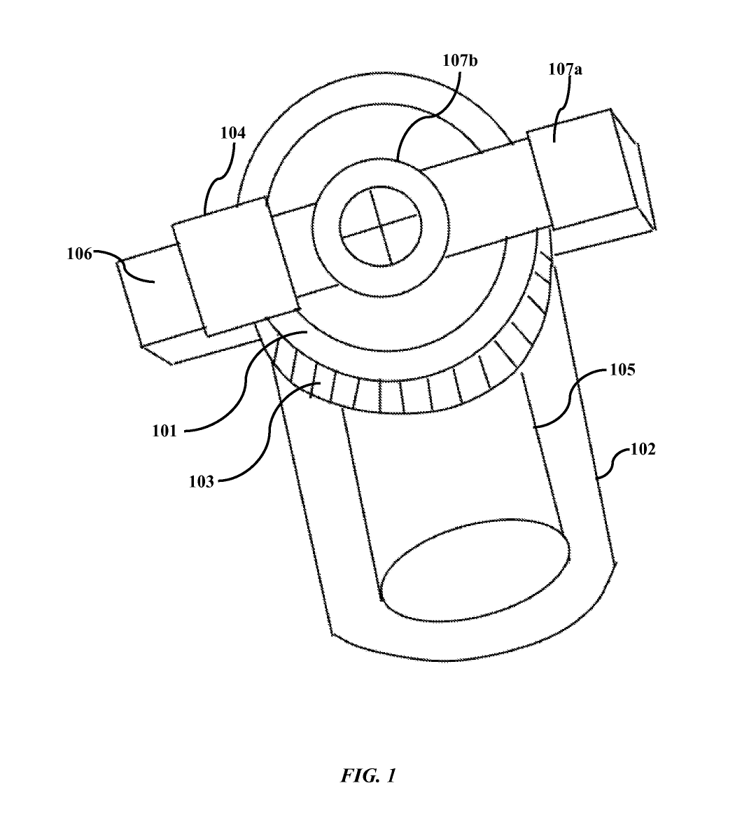

FIG. 1 illustrates a perspective view of a poly-magnetic filter, according to an embodiment herein. With respect to FIG. 1, the poly-magnetic fitter comprises a filter body 101, a transparent housing 102, a plastic flange 103, a magnetic power unit 104, a polyphosphate filter 105, a water inlet port 106 and at least two outlet ports 107a and 107b. The filter body 101 is act as a connecting part for the filter. The filter body integrates the water inlet port 106, the magnetic power unit 104 and the two water outlet port 107a and 107b. The magnetic power unit 104 is embedded into the inlet port 106, so that the magnetic power unit 104 is not far from the appliance. Meanwhile the water molecules are regularized because of the adjacency of the filter with the magnetic unit 104. The filter body 101 comprises a rim around a top opening. The transparent housing 102 is connected to the top opening of the filter body 101. The plastic flange 103 is in form of a ring and comprises a rim used for fastening the transparent housing 102 to the filter body 101.

The inlet port 106 is made up of forged brass, which enables the port to be highly resistant and shatterproof. The inlet port 106 is connected to the output pipe of the water supply source. The inlet port 106 is configured to provide an entry to the untreated water from the water supply source into the filter body 101. The magnetic power unit 104 is positioned after the input port, which is configured to regulate the water molecules as the water flows through the filter body 101.

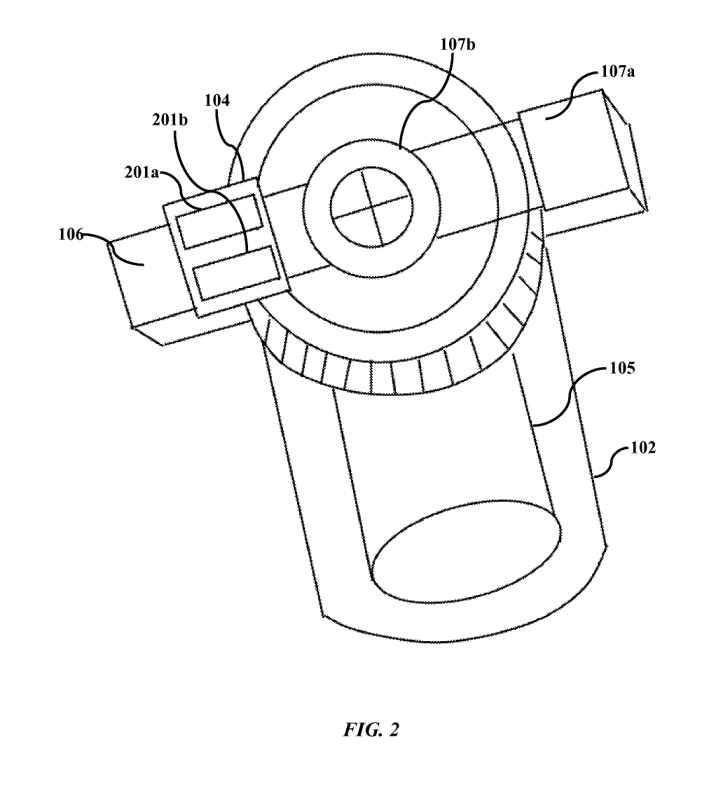

FIG. 2 illustrates a perspective view of the poly-magnetic filter, exposing the magnetic blocks in the magnetic power unit, according to an embodiment herein. With respect to FIG. 2, the magnetic power unit 104 is configured for breaking down the limestone molecules in water using the magnetic field effect. The magnetic power unit 104 comprises at least two magnet blocks 201a and 201b. The magnetic blocks 201a and 201b are in the form of bar magnets. The magnetic power unit 104 further comprises a cap for covering the top opening of the magnetic power unit and to enclose the magnet blocks (as shown in FIG. 1). The Cap is fastened to the filter body b a plurality of screws. Each magnet block of the magnetic power unit is a rare-earth permanent magnet and preferably the magnet block is a Neodymium magnet. The Neodymium magnet is the strongest permanent magnet and has long life power than other kinds of magnets. The two neodymium magnets 201a and 201b are placed on either side of the inlet port 106 and the water entering the magnet power unit passes through a strong, uniform magnetic field. The magnetic power unit 104 is positioned prior to the polyphosphate cartridge 105 to primarily soften the untreated water and the polyphosphate cartridge 105 further filters the softened water obtained from the magnetic power unit 104. The water is exposed to the magnetic field as it flows through the pipe between the magnets 201a and 201b. The magnetic field created in the magnetic power unit breaks 104 down the limestone molecules to precipitate as aragonite, a crystalline modification of limestone. The aragonite is soft powdery precipitate tape type talc which remains in the form of suspension and prevents reformation of the limescale. The untreated Water is influenced by Neodymium magnets 201a and 201b and most of the lime molecules are broken down due to the magnetic power and are no longer able to precipitate on water molecules. The water is softened.

The poly-magnetic filter comprises the transparent housing 102 which is configured to store the softened water incoming from the magnetic power filter 104. The transparent housing 102 is made up of Styrene-acrylonitrile resin material or polycarbonate material. The polyphosphate cartridge 105 is mounted in a removable manner on the transparent housing 102. The polyphosphate cartridge 105 is configured to further soften the water which was treated by the magnetic power unit 104. The polyphosphate cartridge 105 is cylindrical in shape and comprises a lower plate and an upper plate arranged on either ends of the cylinder. The polyphosphate cartridge 105 comprises an opening at the lower plate through which the treated water from the magnetic power unit 104 enters the polyphosphate cartridge 105. The polyphosphate cartridge 105 comprises a plurality of polyphosphate beads constituting means for removing the limestone molecules from the untreated water. The polyphosphate cartridge 105 comprises a cover having an opening for passing the filtered liquid from the upper plate of the polyphosphate cartridge 105. The softened water from the magnetic power unit 104 is filled in the transparent housing 102. The water in the transparent housing 102 slowly enters the polyphosphate cartridge 105 from the lower part of the cartridge 105. Then, the remaining limestone is mingled with sodium hexamethazone and completely broken down after contiguity with polyphosphate crystals. The water molecules strike with the polyphosphate crystals and the lime molecules are removed from water due to double impact. The process enables a total removal of limestone after passing through the cartridge 105 of the filter. The magnetic effect on the untreated water is the first effect for preventing a formation of limestone and molecular dissociation. The water further reacts with polyphosphate crystals and forms water molecular combination with sodium hexamethazone so as to facilitate a complete dissociation of limestone, thereby completely avoiding the formation of limestone when the water exits from the water outlet port 107.

The poly-magnetic filter comprises two outlet ports 107a and 107b which are configured for providing an exit to filtered water. A user chooses any one of the outlet ports 107a and 107b depending on convenience. The first outlet port-A 107a is placed opposite to the inlet port and is perpendicular to the second outlet port-B 107b. Any one of the outlet ports is selected depending on the position of the pipe system of the appliance to which the filter is being connected. The outlet port-A 107a is connected to an input valve of the appliance whereas the second outlet port-B 107b is closed with a covering cap or vice versa.

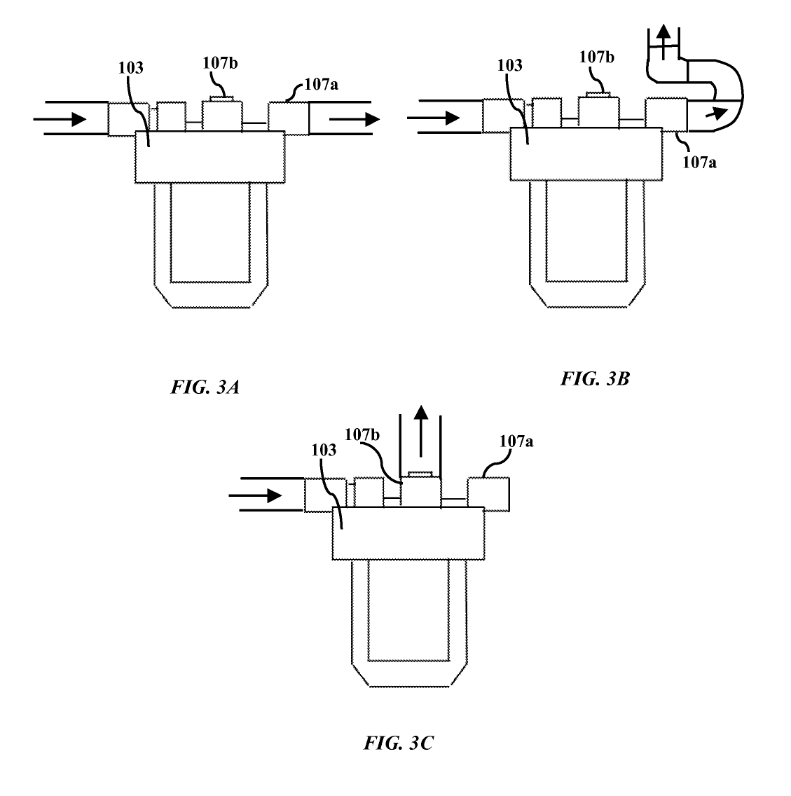

FIG. 3A, 3b and 3C illustrate a side view of the poly-magnetic filter indicating a plurality of configurations for connecting a piping system of an appliance to output ports of the poly-magnetic filter, according to an embodiment herein. The purpose of two output ports is for easier installation. An installer, in some position need to install the filter in straight way and in some other positions the filter needs to be installed in right-angle due to the position pipe system and position of the appliances. The water outlet port-A 107a is selected when the pipe system is parallel to a plane of the said filter (Shown in FIG. 3A). The second outlet port-B 107b is selected when the pipe system is perpendicular to the plane of the filter (Shown in FIG. 3C). The outlet port-B 107b enables the installer to directly fit the filter in right angle to the normal plane, thereby preventing the bending of connected pipes (Shown in FIG. 3B) and eliminating the use of a lot of fitting for installation. The outlet ports are made up of brass material.

According to an embodiment herein, the installer needs to find the input water pipe of the appliance being connected to the filter before installation. The installer must be sure that the size of the pipe is at least half an inch because all the brass ports have dimension of half an inch. When the size of input water pipe is different, the installer must use a convertor/reducer/coupler from other size to half inch so as to install the polymagnet filter. During the filter installation, firstly the filter body is connected between the water supply source and the appliance. The installer opens the plastic flange 103 and detaches the transparent housing and polyphosphate cartridge from the filter body. The installer then connects the filter body to the pipes of water supply source and appliance. The installer further places the cartridge in the housing and then fastens the housing and the cartridge to the filter body, using plastic flange 103.

The various embodiments herein provide a method for removing a plurality of limestone molecules from the untreated water using a poly-magnetic filter. The embodiments herein further provide the filtering method which primarily regulates the water molecules using the magnetic arc and further softens the water molecules using the poly-phosphate crystals.

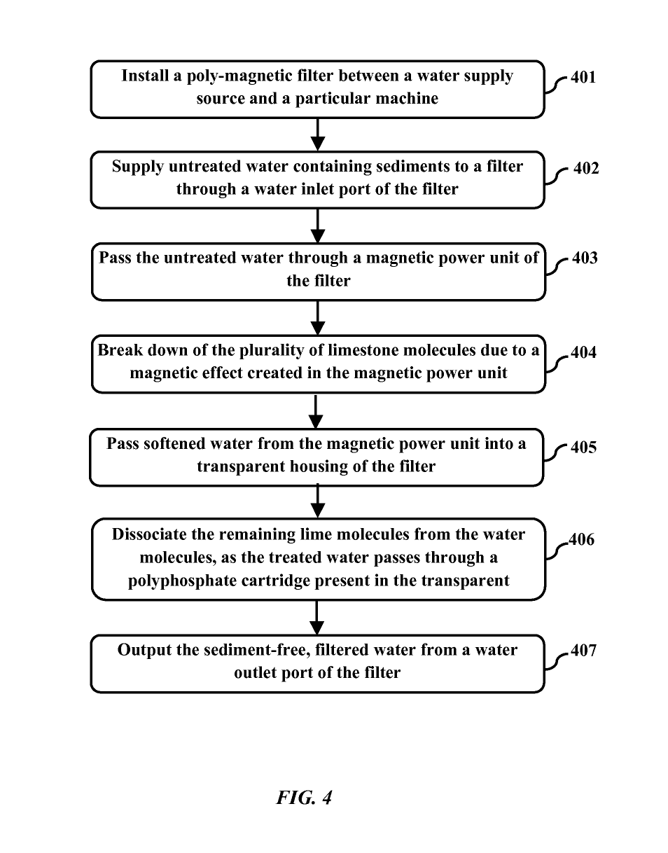

FIG. 4 illustrates a flowchart explaining the process steps involved in a method for removing a plurality of limestone molecules from untie water using a poly-magnetic filter, according to embodiment herein. The method comprises the following steps. The poly-magnetic filter is installed between a water supply source and a particular appliance (401). The untreated water containing sediments is passed to a filter through a water inlet port of the filter (402). The untreated water is passed through a magnetic power unit of the filter (401). The plurality of limestone molecules is broken down due to a magnetic effect of the magnet blocks in the magnetic power unit of the filter (404). The magnetic effect created in the magnetic power unit, breaks down the plurality of limestone molecules in the untreated water into soft powdery precipitate tape type talc which remains in form of suspension. The magnetic effect also prevents further formation of lime scale in the softened water. The softened water from the magnetic power unit is passed into a transparent housing of the filter (405). The untreated water is filtered twice by passing the treated water from magnet power unit to the polyphosphate cartridge. The remaining limestone molecules react with sodium hexamethazone in the polyphosphate cartridge, to cause a total removal of the limestone molecules in filtered water. The lime molecules are dissociated from the water molecules, as the treated water passes through the polyphosphate cartridge present in the transparent housing of the filter (406). The sediment-free, filtered water is output from a water outlet port of the filter (407).

The filter disclosed in the embodiments herein provides the effect of neutralizing the lime simultaneously by using magnetic are and polyphosphate crystal. Further the filter facilitates a double impact on regularized water molecules by means of magnetic arc that two through the crystal housing to strengthen the functionality of crystals. The sole function of magnetic arc to filer the water effectively even when the user lacks attention to the expiry or exhaustion of crystals. The filer compensated the lack of water pressure falling and the amount of water in every second in case the water pressure falls down. The filter uses two output ports for easier installation and preventing unnecessary costs.

The important reasons for using NI) magnet are related to power of magnet and quality. When compared with other kind of magnet, we insure that ND magnet is best choice for this filter also. The magnet (NdFeB) mainly comprising neodymium. Iron and Boron, is the third generation of the rare-earth permanent magnet. Sintered NdFeB is the strongest permanent magnet in the world up to date. The most powerful Rare Earth magnet available today, possesses high energy ranging from 8 MGOe to 64 MGOe and wonderful coercive force. NdFeB magnet is used as polymagnet the filter because this kind of magnet is most powerful and has long life power (more than 30 years) while other kinds of magnet have less power and shorter time for effect of power of magnet.

The foregoing description of the specific embodiments will so fully reveal the general nature of the embodiments herein that others an by applying current knowledge, readily modify and/or adapt for various applications such specific embodiments without departing from the generic concept, and, therefore, such adaptations and modifications should and are intended to be comprehended within the meaning, and range of equivalents of the disclosed embodiments. It is to be understood that the phraseology or terminology employed herein is for the purpose of description and not of limitation. Therefore, while the embodiments herein have been described in terms of preferred embodiments those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A poly-magnetic filter for separating a plurality of limestone molecules in untreated water comprises:
a filter body wherein the filter body comprises a rim around a top opening;
a transparent housing configured for storing an untreated water, and wherein the transparent housing is connected to the top opening of the filter body;
a plastic flange in a form of a ring, wherein the plastic flange comprises a rim used for fastening the transparent housing to the filter body.
an water inlet port configured tier providing an entry to an untreated water into the filter body;
a plurality of outlet ports configured for providing an exit to a filtered water, wherein a user chooses any one of the plurality of outlet ports depending convenience;
a magnetic power unit configured for breaking down limestone molecules in water using a magnetic field effect;
a polyphosphate cartridge mounted in a removable manner on the transparent housing, and wherein the polyphosphate cartridge is configured to soften the water treated by the magnetic power unit;
wherein the filter is placed inside or outside a water-using domestic appliance or industrial appliance, and wherein the filter is installed at a water inlet point of the appliance.

2. The system according to claim 1, wherein the magnetic power unit is positioned prior to the polyphosphate cartridge, and wherein the magnetic power unit softens the untreated water, and wherein the polyphosphate cartridge filters the softened water obtained from the magnetic power unit.

3. The system according to claim 1 wherein the water inlet port is arranged at an end of the filter body, and wherein the inlet port is connected to an output pipe of a water supply source.

4. The system according, to claim 1, wherein the two outlet ports are arranged on the filter body, wherein a first outlet port is placed opposite to the inlet per and is perpendicular to second outlet port, wherein the outlet port is selected depending on the position of a pipe system of the appliance.

5. The system according to claim 1, wherein the first outlet port is connected to an input valve of the appliance and wherein the second outlet port is closed with a covering cap or vice versa.

6. The system according to claim 1, wherein the magnetic power unit comprises at least two magnet blocks, and wherein the magnet blocks are in form of bar magnets, wherein each magnet block of the magnetic power unit is rare-earth permanent magnet, and wherein the magnet block is a Neodymium magnet.

7. The system according to claim 1, where the magnetic power unit comprises a cap for covering the top opening of the magnetic power unit, wherein the cap is provided to enclose the magnet blocks.

8. The system according to claim 1, wherein the transparent housing is configured to store the treated water coming from the magnetic power unit, wherein the transparent housing is made up of Styrene-acrylonitrile resin material or polycarbonate material.

9. The system according to claim 1, wherein the polyphosphate cartridge comprises an opening at a lower part through which the treated water from the magnetic power unit enters into the polyphosphate cartridge.

10. The system according to claim 1, wherein the polyphosphate cartridge comprises a plurality of polyphosphate beads formation unit for removing the limestone molecules from the untreated water.

11. The system according to claim 1, wherein the polyphosphate cartridge comprises a cover having an opening for passing the filtered liquid from the upper portion of the polyphosphate cartridge.

12. A method for removing a plurality of limestone molecules from untreated water using a poly-magnetic filter comprising steps of:
installing a poly-magnetic filter between a water supply source and a particular appliance;
supplying an untreated water containing sediments to a filter through an water inlet port of the filter;
passing the untreated water through a magnetic power unit of the filter;
breaking down of the plurality of limestone molecules due to a magnetic effect of the magnet blocks in the magnetic power unit of the filter;
passing softened water from the magnetic power unit into a transparent housing of the filter;
dissociating the lime molecules from the water molecules, as the treated water passes through a polyphosphate cartridge present in the transparent housing of the filter; and
outputting the sediment-free, filtered water from a water outlet port of the filter.

13. The method according to claim 12, wherein the filter body is installed between an output pipe of the water supply source and an input valve of the appliance, and wherein the polyphosphate cartridge along with the transparent housing is fixed to the filter body after the installation, using a plastic flange.

14. The method according to claim 12, wherein the magnetic zone created in the magnetic power unit, breaks down the plurality of limestone molecules in the untreated water, wherein the magnetic zone breaks down the limestone molecules into soft powdery precipitate tape type talc which remains in form of suspension.

15. The method according to claim 12, wherein the untreated water is filtered twice by passing the treated water from the magnet power unit to the polyphosphate cartridge, wherein the remaining limestone molecules react with sodium hexamethazone in the polyphosphate cartridge, to cause a total removal of the limestone molecules in filtered water.

16. The method according to claim 12, wherein the filtered water is removed through one of the two water outlet ports of the filter, and wherein the outlet port is selected depending on a pipe system of the appliance, and wherein a first water outlet port is selected when the pipe system is arranged in parallel to a plane of the filter, and wherein a second outlet port is selected when the pipe system is perpendicular to the plane of the filter.
